(19) United States
(12) Patent Application Publication
(10) Pub. No.: US 2025/0150407 A1
(43) Pub. Date: May 8, 2025

(54) CONTROL DEVICE, CONTROL METHOD AND CONTROL PROGRAM

(71) Applicant: Nippon Telegraph and Telephone Corporation, Tokyo (JP)

(72) Inventors: Hiroki IWAHASHI, Musashino-shi, Tokyo (JP); Satoshi NAKATSUKASA, Musashino-shi, Tokyo (JP); Masato NISHIGUCHI, Musashino-shi, Tokyo (JP); Toshiyuki KANAZAWA, Musashino-shi, Tokyo (JP); Takahiro SHIBATA, Musashino-shi, Tokyo (JP)

(21) Appl. No.: 18/684,273

(22) PCT Filed: Aug. 27, 2021
(86) PCT No.: PCT/JP2021/031613

§ 371 Date: Feb. 16, 2024

(51) Int. Cl. H04L 47/70

(52) U.S. Cl. CPC H04L 47/70

(57) ABSTRACT

A host system handling unit receives an accommodation switch instruction for switching the accommodation position of a specific user accommodated in a predetermined communication device to another communication device, the predetermined communication device being included in a plurality of communication devices accommodating users who use a network. A device management unit acquires information about possible accommodation switch destinations corresponding to the predetermined communication device from an external file in which one or more communication devices to be an accommodation switch destination are associated with each communication device and are registered, and selects the communication device of the accommodation switch destination from among the acquired possible accommodation switch destinations. A device control unit performs accommodation switching so that the specific user is accommodated in the communication device of the accommodation switch destination selected by the device management unit.

### TECHNICAL FIELD

The present invention relates to a management device, a management method, and a management program.

### BACKGROUND ART

There has been a technique for appropriately selecting a communication device that accommodates users in accordance with the available resources of each communication equipment by collecting and managing, in an integrated manner, resources such as the bands of the communication devices constituting a network, the number of settable filters, and the number of sessions that can be established. With this technique, it is possible to flexibly accommodate users while maintaining constant user communication quality. Setting in a communication device selected by a user to be accommodated is performed by registering setting information called a user configuration in each communication device.

For example, a centralized management server manages the available resources of each communication device in the network. The centralized management server then determines the communication device, the link aggregation group (LAG), or the physical port to accommodates new users, in accordance with the available resources of each communication device. Next, the centralized management server inputs a configuration for the user to the determined communication device as the accommodation switch destination. After that, the user's communication is established in the communication device having the configuration input thereto. Thus, resource optimization can be achieved in each device.

The centralized management server can also change a user's accommodation position in the following cases. One of such cases is the case of an accommodation position change called a failure accommodation switch. This is a case where, when an edge router, or a LAG or a physical port under the control of the edge router, is disconnected due to a failure or the like, the centralized management server relocates the users accommodated in the LAG or the physical port that has been disconnected, to another accommodation position, so as to maintain and continue the user communication. Basically, quick switching is required at the time of a failure. Meanwhile, it is also necessary to take into consideration the available resources at the accommodation switch destination. Since it is not very suitable for the maintenance personnel to determine the accommodation switch destination also taking the available resources into consideration in the presence of a large number of possible accommodation switch destinations in a situation where a quick response is required, an accommodation switch destination is normally automatically selected by the centralized management server. For example, as an example of a redundant requirement for performing a failure accommodation switch, there is a method by which two specific edges are paired, and, when one of the edges fails, a failure accommodation switch to the other edge is performed.

The other one of the above cases is the case of an accommodation position change called a maintenance accommodation switch. This is a case where the centralized management server temporarily relocates the users to another accommodation position due to maintenance work such as router software update. In this case, the accommodation switch destination can be either designated by the maintenance personnel or be automatically selected by the centralized management server.

### CITATION LIST

### Non Patent Literature

Non Patent Literature 1: Iwahashi et al., “Edge Router ni okeru jyunan-na user shuyou houhou no kentou (in Japanese) (Study on flexible user accommodating method in edge router)”, IEICE General Conference, B-6-58, March 2020 Non Patent Literature 2: Iwahashi et al., “Edge router ni okeru user shuyou jyunanka system no bunsan kousei teian (in Japanese) (Proposal on distributed configuration of flexible user accommodation system in edge router)”, The Institute of Electronics, Information and Communication Engineers (IEICE) Society Conference, B-6-1, September 2020

### SUMMARY OF INVENTION

### Technical Problem

However, there are cases where the accommodation position of a user is used as authentication information in user authentication in a dynamic host configuration protocol (DHCP) server or the like, or cases where it is preferable to limit communication devices or LAGs that can accommodate users in one edge group, depending on the number of users that can be processed by a server and the redundant requirement in a server that provides a specific service. An edge group is a group of edge routers that are capable of accommodating users and have network reachability. Edge groups are often divided for each service providing area. In these cases, an edge router to which accommodation can be switched in accordance with an internal accommodation position determination logic when viewed only from the centralized management server might be different from an edge router that is desired to be the accommodation switch destination when viewed in an external system or a maintenance operation. However, it is difficult to completely design such limitations and such an accommodation position selection logic at the construction stage.

Furthermore, there are cases where switching is desired depending on the providing area, the service, or the like. For example, it is conceivable that a request is made to use not a pair but a set of three units so as to increase accommodation efficiency, or a request is made to temporarily allow an accommodation switch to the outside the pairs so as to increase maintenance work efficiency. However, by a conventional accommodation position selection method, an accommodation switch destination is determined through automatic selection by a server or designation by the user each time. Therefore, it is difficult to flexibly and efficiently cope with a requirement change after verification or operation. As described above, by a conventional accommodation position determination method, it is difficult to flexibly cope with the limitations on accommodation destinations, and it is difficult to increase the stability of the system.

### Solution to Problem

To solve the above problem and achieve the object, a management device includes the following components. A host system handling unit receives an accommodation switch instruction for switching the accommodation position of a specific user accommodated in a predetermined communication device to another communication device, the predetermined communication device being included in a plurality of communication devices accommodating users who use a network. A device management unit acquires information about possible accommodation switch destinations corresponding to the predetermined communication device from an external file in which one or more communication devices to be an accommodation switch destination are associated with each communication device and are registered, and selects the communication device of the accommodation switch destination from among the acquired possible accommodation switch destinations. A device control unit performs accommodation switching so that the specific user is accommodated in the communication device of the accommodation switch destination selected by the device management unit.

### Advantageous Effects of Invention

According to the present invention, it is possible to flexibly cope with limitations on accommodation switch destinations, and increase stability of a communication system.

### BRIEF DESCRIPTION OF DRAWINGS

FIG. 1 is a block diagram of a centralized management server according to an embodiment.

FIG. 2 is a chart illustrating an example of an accommodation switch file.

FIG. 3 is a diagram illustrating an outline of an example of an accommodation switch process to be performed by the centralized management server according to the embodiment.

FIG. 4 is a diagram illustrating an accommodation switch logic implemented by a device management unit according to the embodiment.

FIG. 5 is a diagram illustrating an example of an accommodation switch process.

FIG. 6 is a flowchart of an accommodation switch process to be performed at the time of a maintenance accommodation switch by the centralized management server according to the embodiment.

FIG. 7 is a flowchart of an accommodation switch process to be performed at the time of a failure accommodation switch by the centralized management server according to the embodiment.

FIG. 8 is a diagram illustrating an example of a computer that executes a management program.

### DESCRIPTION OF EMBODIMENTS

The following is a detailed description of embodiments of a management device, a management method, and a management program disclosed in the present application, with reference to the drawings. Note that the embodiments described below do not limit the management device, the management method, and the management program disclosed in the present application.

### Configuration According to an Embodiment

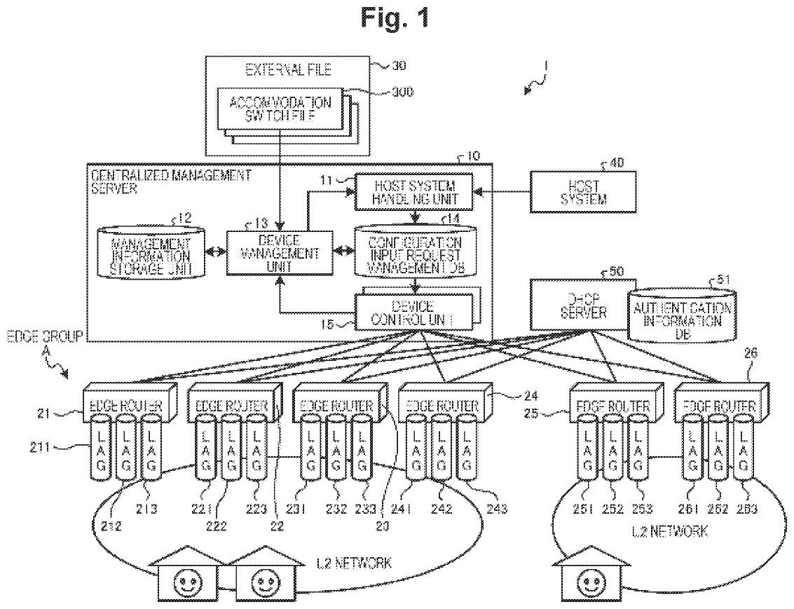

FIG. 1 is a block diagram of a centralized management server according to an embodiment. Referring to FIG. 1, the configuration of a management system 1 according to the embodiment is described.

As illustrated in FIG. 1, the management system 1 includes a centralized management server 10, edge routers 21 to 26, and an external file 30. In the description below, the edge routers 21 to 26 will be referred to as “edge routers 20” in a case where they are not distinguished from one another. Further, the centralized management server 10 is connected to a host system 40.

The edge router 21 has LAGs 211 to 213. The edge router 22 has LAGs 221 to 223. The edge router 23 has LAGs 231 to 233. The edge router 24 has LAGs 241 to 243. The edge router 25 has LAGs 251 to 253. The edge router 26 has LAGs 261 to 263. In the description below, the LAGs 211 to 213, 221 to 223, 231 to 233, 241 to 243, 251 to 253, and 261 to 263 will be referred to as “LAGs 200” in a case where they are not distinguished from one another. LAGs 200 can form one LAG 200 over different edge routers 20. For example, the LAG 212 and the LAG 222 may be identical LAGs 200, and the LAG 231 and the LAG 241 may be identical LAGs 200.

The edge routers 20 accommodate users who use communication services. The edge routers 20 are also connected to a DHCP server 50. Further, each edge router 20 is connected to an L2 network by one or a plurality of LAGs 200. Terminal devices of users are connected to an L2 network, and the edge routers 20 transmit and receive data to and from the terminal devices via the L2 network.

The host system 40 transmits a configuration input request to the centralized management server 10. Note that the functions of the host system 40 may be realized by an operator. In that case, the operator inputs the details of the configuration input request to the centralized management server 10. A configuration input is to set a user configuration for the edge routers 20 accommodating users, and conduct settings associated with service launches, changes, cancellations, and the like. The user configuration also includes setting of switching of accommodation destination devices. Further, setting information about the configuration input request may include designation of the input destination device.

The DHCP server 50 holds an authentication information DB 51 in which authentication information indicating a set of user identification information and accommodation positions is stored. The DHCP server 50 performs user authentication using the authentication information, and internet protocol (IP) address allocation to each user. The accommodation positions that can accommodate the respective users are limited, so that the data amount of the authentication information can be reduced.

The external file 30 is a file to which the centralized management server 10 can refer. With the external file 30, it is easy to update the registered data, for example. The external file 30 includes an accommodation switch file 300 in which information about possible accommodation switch destinations is registered.

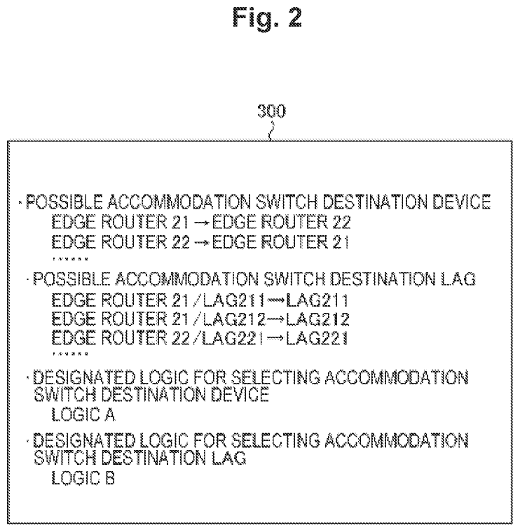

FIG. 2 is a chart illustrating an example of an accommodation switch file. In the accommodation switch file 300, as illustrated in FIG. 2, information about the edge routers 20 serving as accommodation switch destination devices for the respective edge routers 20 is registered. The number of accommodation switch destination devices registered for one edge router 20 may be one or more. That is, a set of two edge routers 20 may be set as possible accommodation switch destination devices, or some or all of the edge routers 20 included in each set may be possible accommodation switch destinations, with three or more edge routers being one set for higher accommodation efficiency, instead of a pair.

Also, as illustrated in FIG. 2, information about the LAGs 200 serving as the accommodation switch destination LAGs for the respective LAGs 200 is registered in the accommodation switch file 300. The number of accommodation switch destination LAGs registered for one LAG 200 may be one or more. In FIG. 2, identical LAGs are set as accommodation switch destination LAGs.

Also, in the accommodation switch file 300, a logic for selecting an accommodation switch destination device in a case where there is a plurality of possible accommodation switch destination devices is registered. Further, in the accommodation switch file 300, a logic for selecting an accommodation switch destination LAG in a case where there is a plurality of possible accommodation switch destination LAGs is registered. Here, a logic for selecting a plurality of accommodation switch destination devices and a logic for selecting a plurality of accommodation switch destination LAGs may be registered in the accommodation switch file 300. As the logic registered in the accommodation switch file 300, the position (a device or a LAG) having the smallest number of users or the position having the smallest number of specific resources (such as the PPPoE (Point-to-Point Protocol over Ethernet (registered trademark)) session number) consumed for each service may be selected, or an address band of other users, a virtual network enabler (VNE) company, and the like may be determined for each device and be selected therefrom, for example.

Further, the external file 30 includes a plurality of different accommodation switch files 300 so that selection can be made in accordance with user management information indicating the user's usage state of an L2 network, such as a contract service, an accommodation area, and a service provision status of the user. For example, an accommodation switch file 300 may be prepared so that an edge router 20 having a range in which accommodation can be switched at a time of a large-scale failure, instead of the normal range, can be selected as an accommodation switch destination device in a case where a large-scale failure occurs in an edge router 20 due to a severe disaster or the like.

In this case, the accommodation switch file 300 corresponds to an example of an “individual file”. That is, in the external file 30, one or more communication devices serving as accommodation switch destinations are registered and associated with each of the communication devices in the accommodation switch file 300.

Further, at the time of introduction, possible accommodation switch destinations are designated for each accommodation switch source device and each accommodation switch source LAG. However, at the time of a requirement change, the possible accommodation switch destination devices and the possible accommodation switch destination LAGs in the accommodation switch file 300 are rewritten. For example, the paired edge routers 20 are set as possible accommodation switch destination devices at the time of introduction, but some or all of the edge routers 20 included in each set may be set as the possible accommodation switch destination devices, with a plurality of edge routers being one set after operation. As a result, accommodation switch destinations can be made flexible, and it is possible to flexibly and efficiently cope with a requirement change even after verification or operation.

The centralized management server 10 includes a host system handling unit 11, a management information storage unit 12, a device management unit 13, a configuration input request management DB 14, and a plurality of device control units 15.

The centralized management server 10 may be formed with a plurality of computers, or may be formed with one computer. That is, each of the host system handling unit 11, the management information storage unit 12, the device management unit 13, the configuration input request management DB 14, and the plurality of device control units 15 is formed with one or a plurality of physical machines or virtual machines. In FIG. 1, the centralized management server 10 is connected to the edge routers 21 to 26 allocated to the respective device control units 15.

The host system handling unit 11 receives general requests from the host system 40 including an operator, such as a configuration input request and an accommodation switch instruction from the host system 40. The host system handling unit 11 registers the received configuration input request in the configuration input request management DB 14.

The configuration input request management DB 14 accepts the registration of the configuration input request from the host system handling unit 11. By doing so, the configuration input request management DB 14 stores the contents of the configuration input request, for each of the edge routers 20 accommodating users who use the L2 network. Also, in the configuration input request management DB 14, information for identifying the edge router 20 determined to be the configuration input destination corresponding to the contents of the configuration input request is stored by the device management unit 13.

The management information storage unit 12 stores information about the resource status of each edge router 20 and the accommodation position of each user. The management information storage unit 12 also holds user management information such as the contract service, the accommodation area, and the service provision status of each user. The user management information may further include the address, the user identifier, the communication band, the fee, and the like of each user.

The device management unit 13 performs an accommodation management process based on the resource status of each edge router 20, such as determination of the accommodation device of each user and accommodation switching, and, other than the accommodation management process, a general control process on each edge router 20. The general control process includes a control process on the edge router 20 based on information other than the resource status, such as automatically blocking communication being performed by the edge router 20 in a case where communication due to virus infection, an attack packet, or the like is detected in the communication being performed by the edge router 20, for example. In addition to that, the general control process may include a new control process based on the resource status, other than the accommodation management process.

The device management unit 13 regularly monitors the configuration input request management DB 14. When confirming that a configuration input request is registered, the device management unit 13 acquires the setting contents of the user configuration designated by the configuration input request.

Next, the device management unit 13 acquires the resource status of each edge router 20 from the device control units 15. The device management unit 13 then determines the edge router 20 on which a configuration input is to be performed among the plurality of edge routers 20, on the basis of the setting information included in the configuration input request, the setting contents of the user configuration, and the availability of the resources of the plurality of edge routers 20. After that, the device management unit 13 associates the information for identifying the edge router 20 determined to be the configuration input destination with the user configuration to be input, and stores the information into the configuration input request management DB 14.

In particular, in a case where the setting contents of the user configuration designated by the configuration input request is an accommodation switch instruction, the device management unit 13 performs an accommodation switch process that will be described later. A case where an accommodation switch instruction is given by a configuration input request may be a case where the user is temporarily moved to another accommodation position due to maintenance work such as software update in the edge router 20, for example. Other than that, in a case where a failure occurs in an edge router 20, and the maintenance worker determines an accommodation switch, an accommodation switch instruction may also be given by a configuration input request.

Here, the device management unit 13 may create a backup of the input user configuration. In that case, the device management unit 13 determines the edge router 20 serving as the backup destination of the user configuration. After that, the device management unit 13 associates the information for identifying the edge router 20 determined to be the user configuration backup destination with the user configuration backup creation instruction, and stores the information into the configuration input request management DB 14.

The device management unit 13 also acquires the resource status of each edge router 20 from the device control units 15. Next, the device management unit 13 determines whether to perform accommodation switching for changing accommodation positions of the user, from the acquired resource status. For example, in a case where communication is disconnected due to a failure or the like in an edge router 20, or a LAG 200 or the physical port under the control of the edge router 20, the device management unit 13 determines to perform accommodation switching. In a case where accommodation switching is not to be performed, the device management unit 13 ends the accommodation switch process depending on changes in the resource status. In a case where accommodation switching is to be performed, on the other hand, the device management unit 13 performs the accommodation switch process described below.

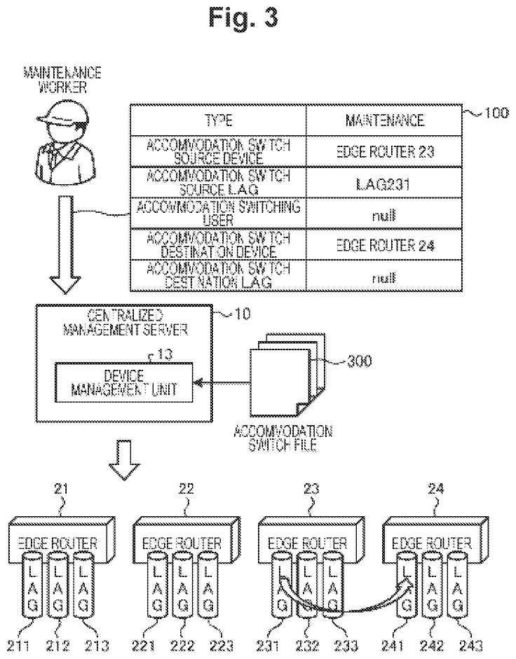

In the description below, the accommodation switch process is explained. FIG. 3 is a diagram illustrating an outline of an example of the accommodation switch process to be performed by the centralized management server according to the embodiment. First, an outline of the accommodation switch process to be performed by the centralized management server 10 is described with reference to FIG. 3.

The centralized management server 10 receives an input of an accommodation switch instruction from a maintenance worker via the host system 40. Here, the accommodation switch instruction is issued with the use of a configuration input request, and, as indicated by information 100, the accommodation switch source device, the accommodation switch source LAG, the accommodation switching user, the accommodation switch destination device, and the accommodation switch destination LAG can be designated in the instruction. Here, as for the information about the accommodation switch source device and the accommodation switch source LAG, there are cases where the device is designated without designation of the LAG, cases where both the device and the LAG are designated, and cases where neither is designated but designation is received from the user at the time of execution of the accommodation switch. In a case where the device is designated without designation of the LAG, all users accommodated in the device are the targets of the accommodation switch. In a case where both the device and the LAG are designated, all the users accommodated in the device and the LAG are the targets of the accommodation switch.

The device management unit 13 of the centralized management server 10 then refers to the accommodation switch file 300 included in the external file 30, and selects the accommodation switch destination device and the accommodation switch destination LAG. For example, in a case where the contents of the information 100 are designated, the device management unit 13 determines, from the accommodation switch file 300, whether the edge router 24 can be selected as the accommodation switch destination device for the user accommodated in the edge router 23. The device management unit 13 also selects the LAG 241 as the accommodation switch destination LAG for the LAG 231, in accordance with the accommodation switch file 300. The device management unit 13 then sets, in the edge router 24, the user configuration for performing accommodation switching to the LAG 241 of the edge router 24, and enables the accommodation switching.

Next, the operation of the device management unit 13 in the accommodation switch process having the above outline is described in detail. When receiving an accommodation switch instruction, the device management unit 13 acquires the user management information about the user whose accommodation positions are to be switched, from the management information storage unit 12. The device management unit 13 then selects and acquires the accommodation switch file 300 from among the accommodation switch files 300 included in the external file 30, in accordance with the contract service, the accommodation area, the service provision status, and the like of the user whose accommodation positions are to be switched, these pieces of information being included in the user management information. That is, the device management unit 13 acquires the user management information about a specific user, and selects an individual file on the basis of the acquired user management information about the specific user.

Next, the device management unit 13 acquires information about the possible accommodation switch destination devices for the accommodation switch source device registered in the acquired accommodation switch file 300. The device management unit 13 further acquires information about the possible accommodation switch destination LAGs for the accommodation switch source LAG registered in the acquired accommodation switch file 300.

Next, the device management unit 13 determines whether the accommodation switch destination device is designated in the accommodation switch instruction. Here, in the case of an accommodation switch instruction given by a configuration input request, the accommodation switch destination device and the accommodation switch destination LAG might be designated by the maintenance worker. On the other hand, in a case where the device management unit 13 determines an accommodation switch in accordance with the resource status, the accommodation switch destination device and the accommodation switch destination LAG are not designated usually.

In a case where the accommodation switch destination device is not designated, the device management unit 13 determines whether the accommodation switch instruction has been issued for a failure accommodation switch or a maintenance accommodation switch. In the case of a failure accommodation switch, quick recovery is required, unlike the case of a maintenance accommodation switch. In view of this, it is assumed that automatic switching is to be performed by the centralized management server 10, and, in the case of a failure accommodation switch, a check is not made to determine whether automatic selection can be performed as in the case of the maintenance accommodation switch described later.

Therefore, in the case of an accommodation switch instruction based on a failure accommodation switch, the device management unit 13 determines whether there is a plurality of possible accommodation switch destination devices. In a case where there is a plurality of possible accommodation switch destination devices, the device management unit 13 selects one accommodation switch destination device from among the possible accommodation switch destination devices, in accordance with the accommodation switch destination device selection logic registered in the accommodation switch file 300. For example, as the accommodation switch destination device selection logic, a logic for selecting an edge router 20 set as a pair in advance as the accommodation switch destination device can be used. In this embodiment, a pair of edge routers 20 is designated in the same edge group. On the other hand, in a case where there is one possible accommodation switch destination device, the device management unit 13 selects the possible accommodation switch destination device as the accommodation switch destination device.

Next, the device management unit 13 determines whether there is a plurality of possible accommodation switch destination LAGs. In a case where there is a plurality of possible accommodation switch destination LAGs, the device management unit 13 selects one accommodation switch destination LAG from among the possible accommodation switch destination LAGs, in accordance with the accommodation switch destination LAG selection logic registered in the accommodation switch file 300. For example, as the accommodation switch destination LAG selection logic, a logic for selecting an identical LAG 200 as the accommodation switch destination LAG can be used. On the other hand, in a case where there is one possible accommodation switch destination LAG, the device management unit 13 selects the possible accommodation switch destination LAG as the accommodation switch destination LAG.

In this embodiment, a case where one logic for selecting the accommodation switch destination device and one logic for selecting the accommodation switch destination LAG are registered has been described. However, a plurality of logics for selecting the accommodation switch destination device and a plurality of logics for selecting the accommodation switch destination LAG may be registered in the accommodation switch file 300. In that case, the device management unit 13 transmits an inquiry as to which logic should be selected to the host system 40 via the host system handling unit 11, and inquires of the maintenance worker. The device management unit 13 may then select the accommodation switch destination device and select the accommodation switch destination LAG, using the logics designated by the maintenance worker in response to the inquiry. That is, the device management unit 13 automatically selects the communication device of the accommodation switch destination from among the possible accommodation switch destinations, using a logic designated among the plurality of logics registered beforehand in the external file.

On the other hand, in the case of an accommodation switch instruction based on a maintenance accommodation switch, the device management unit 13 transmits an inquiry as to whether automatic selection is possible, together with information about the possible accommodation switch destination devices and the possible accommodation switch destination LAGs, to the host system handling unit 11, and makes an inquiry to the maintenance manager. Here, the maintenance manager and the maintenance worker may be the same person or system. After that, in a case where a notification of permission of automatic selection is received via the host system handling unit 11, the device management unit 13 selects the accommodation switch destination device and the accommodation switch destination LAG in the same manner as in a case where an accommodation switch instruction relates to a failure accommodation switch. On the other hand, in a case where automatic selection is not permitted, the device management unit 13 makes a request for designation of the accommodation switch destination device and the accommodation switch destination LAG via the host system handling unit 11, and waits until a new accommodation switch instruction is received.

On the other hand, in a case where the accommodation switch destination device is designated, the device management unit 13 determines whether the designated device is included among the possible accommodation switch destination devices. If the designated device is not included among the possible accommodation switch destination devices, the device management unit 13 transmits an error notification to the host system handling unit 11, and notifies the maintenance worker of the occurrence of an error.

On the other hand, in a case where the designated device is included among the possible accommodation switch destination devices, the device management unit 13 selects the designated device as the accommodation switch destination device. Next, the device management unit 13 determines whether the accommodation switch destination LAG is designated.

In a case where the accommodation switch destination LAG is not designated, the device management unit 13 determines whether the accommodation switch instruction has been issued for a failure accommodation switch or a maintenance accommodation switch. In the case of an accommodation switch instruction based on a failure accommodation switch, the device management unit 13 determines whether there is a plurality of possible accommodation switch destination LAGs. In a case where there is a plurality of possible accommodation switch destination LAGs, the device management unit 13 selects one accommodation switch destination LAG from among the possible accommodation switch destination LAGs, in accordance with the accommodation switch destination LAG selection logic registered in the accommodation switch file 300. On the other hand, in a case where there is one possible accommodation switch destination LAG, the device management unit 13 selects the possible accommodation switch destination LAG as the accommodation switch destination LAG.

On the other hand, in the case of an accommodation switch instruction based on a maintenance accommodation switch, the device management unit 13 transmits an inquiry as to whether automatic selection is possible, together with information about the possible accommodation switch destination LAGs, to the host system handling unit 11, and makes an inquiry to the maintenance manager. After that, in a case where a notification of permission of automatic selection is received via the host system handling unit 11, the device management unit 13 selects the accommodation switch destination LAG in the same manner as in a case where an accommodation switch instruction relates to a failure accommodation switch. On the other hand, in a case where automatic selection is not permitted, the device management unit 13 makes a request for designation of the accommodation switch destination LAG in addition to the earlier designation of the accommodation switch destination device via the host system handling unit 11, and waits until a new accommodation switch instruction is received.

On the other hand, in a case where the accommodation switch destination LAG is designated, the device management unit 13 determines whether the designated LAG 200 is included among the possible accommodation switch destination LAGs. If the designated LAG 200 is not included among the possible accommodation switch destination LAGs, the device management unit 13 transmits an error notification to the host system handling unit 11, and notifies the maintenance worker of the occurrence of an error.

On the other hand, in a case where the designated LAG 200 is included among the possible accommodation switch destination LAGs, the device management unit 13 selects the designated LAG 200 as the accommodation switch destination LAG.

After that, the device management unit 13 switches the accommodation of the user to the selected accommodation switch destination device and accommodation switch destination LAG. Specifically, the device management unit 13 stores, into the configuration input request management DB 14, a configuration input request or the like for instructing an input of the user configuration to the selected accommodation switch destination device and accommodation switch destination LAG. As a result, the designated user's accommodation position is switched to the LAG 200 designated as the accommodation switch destination LAG, the LAG 200 belonging to the edge router 20 designated as the accommodation switch destination device by the device control unit 15.

Here, in the case of a failure accommodation switch, the device management unit 13 preferentially performs configuration setting for the accommodation switch destination, to immediately recover from the communication disconnection. After that, the device management unit 13 performs a configuration operation on the edge router 20 that is the accommodation switch source device, a configuration operation for inducing user session reconnection, and the like.

On the other hand, in the case of a maintenance accommodation switch, to continue user communication, the device management unit 13 collectively performs a configuration operation on the accommodation switch source edge router 20, a configuration operation for inducing user session reconnection, and the like, together with the configuration operation on the accommodation switch destination edge router 20. As a result, the device management unit 13 can minimize the user's communication disconnection in the case of a maintenance accommodation switch.

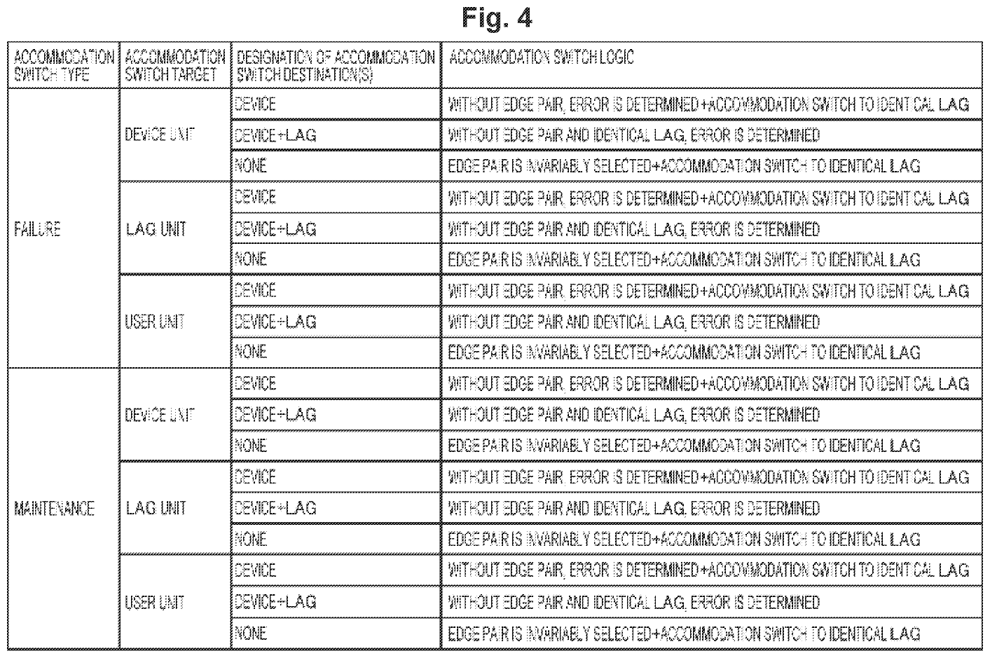

FIG. 4 is a diagram illustrating an accommodation switch logic implemented by the device management unit according to the embodiment. In this embodiment, the accommodation switch logics for a failure accommodation switch and a maintenance accommodation switch are identical, but the flows in accommodation switch processes are different. Therefore, the accommodation switch logics for the respective types of accommodation switches are shown in FIG. 4.

Units of users as accommodation switch targets include devices units, LAG units, and user units. This depends on the scale of maintenance or failure. For example, in a case where the edge router 21 fails, and 32L accommodation switching is performed for all the users accommodated in the edge router 21, the accommodation switching is performed for each device. However, for any accommodation switch target, the accommodation switch logic is the same.

In a case where the accommodation switch destination device is designated, the device management unit 13 determines that there is an error, if the designated device is not the edge router 20 paired with the accommodation switch source device. If the designated device is the edge router 20 paired with the accommodation switch source device, the device management unit 13 selects the accommodation switch destination that is a LAG 200 identical to the accommodation switch source LAG of the designated edge router 20.

Further, in a case where the accommodation switch destination device and the accommodation switch destination LAG are designated, the device management unit 13 determines that there is an error, if the designated device is the edge router 20 paired with the accommodation switch source device, and the designated LAG 200 is not identical to the accommodation switch source LAG. Further, if the designated device is the edge router 20 paired with the accommodation switch source device, and the designated LAG 200 is identical to the accommodation switch source LAG, the device management unit 13 selects those devices as the accommodation switch destinations.

Further, in a case where the accommodation switch destination device and the accommodation switch destination LAG are not designated, the device management unit 13 selects the edge router 20 paired with the accommodation switch source device as the accommodation switch destination device. The device management unit 13 also selects the accommodation switch destination LAG that is a LAG 200 identical to the accommodation switch source LAG.

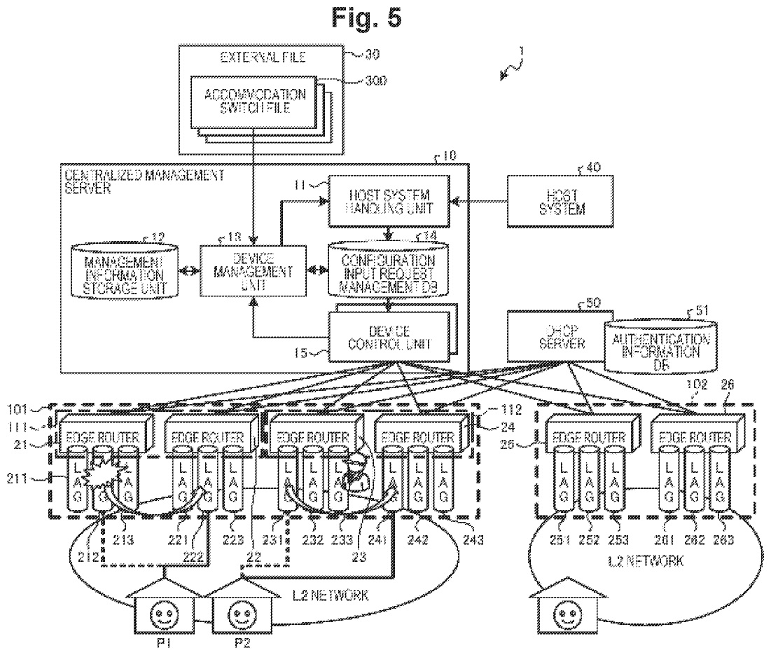

FIG. 5 is a diagram illustrating an example of an accommodation switch process. Here, the edge routers 21 to 24, and the LAGs 211 to 213, 221 to 223, 231 to 233, and 241 to 243 belonging to those edge routers are included in an edge group 101. Meanwhile, the edge routers 25 and 26, and the LAGs 251 to 253 and 261 to 263 belonging to those edge routers are included in an edge group 102. Further, the edge router 21 and the edge router 22 form one pair, and the edge router 23 and the edge router 24 form one pair. Also, the LAG 212 and the LAG 222 are identical LAGs 200, and the LAG 231 and the LAG 241 are identical LAGs 200.

For example, in a case where a failure occurs in the LAG 212 of the edge router 21, and communication is disconnected, the device management unit 13 determines a switch of accommodation of a user P1 accommodated in the LAG 212, in accordance with information sent from the device control unit 15. The device management unit 13 then selects and acquires the accommodation switch file 300 from the user management information about the user P1. Next, in accordance with the acquired accommodation switch file 300, the device management unit 13 selects the accommodation switch destination device that is the edge router 22, which is paired with the edge router 21 that is the accommodation switch source device. The device management unit 13 also selects the accommodation switch destination LAG that is the LAG 222, which is a LAG 200 identical to the accommodation switch source LAG, in accordance with the acquired accommodation switch file 300. The device management unit 13 then sets, in the edge router 22, the user configuration for accommodating the user P1 in the LAG 222. With this arrangement, the position of accommodation of the user P1 is switched from the LAG 212 of the edge router 21 to the LAG 222 of the edge router 22.

Further, in a case where the position of accommodation of a user P2 accommodated in the LAG 231 of the edge router 23 is to be switched due to maintenance, for example, the device management unit 13 confirms that a configuration input request for issuing an instruction to switch the accommodation of the user P2 is stored in the configuration input request management DB 14. Next, the device management unit 13 selects and acquires the accommodation switch file 300 from the user management information about the user P2. The device control unit 15 then determines whether the accommodation switch destination device is designated, and the accommodation switch destination LAG is designated in the user configuration designated by the configuration input request. In a case where the accommodation switch destination device is designated, a check is made to determine whether the designated device is the edge router 24 paired with the edge router 23, and, if a device other than the edge router 24 is designated, an error notification is issued. Further, in a case where the accommodation switch destination LAG is designated, a check is made to determine whether the designated device is the LAG 241, which is a LAG 200 identical to the LAG 231, and, if a device other than the LAG 241 is designated, an error notification is issued. If no errors are determined, the device management unit 13 selects the LAG 241 of the edge router 24 as the accommodation switch destination, in accordance with the accommodation switch file 300 or in accordance with designation from the host system 40. The device management unit 13 then sets, in the edge router 24, the user configuration for accommodating the user P2 in the LAG 241. With this arrangement, the position of accommodation of the user P2 is switched from the LAG 231 of the edge router 23 to the LAG 241 of the edge router 24.

As described above, the device management unit 13 receives an accommodation switch instruction for switching the position of accommodation of a specific user accommodated in a predetermined communication device among a plurality of communication devices accommodating users who use a network to another communication device, acquires information about possible accommodation switch destinations corresponding to the predetermined communication device from an external file in which one or more of the communication devices to be accommodation switch destinations are associated with the respective communication devices and are registered, and selects a communication device as the accommodation switch destination from among the acquired possible accommodation switch destinations. Further, in a case where designation of the communication device of the accommodation switch destination is included in the accommodation switch instruction, the device management unit 13 issues an error notification when the designated communication device of the accommodation switch destination is not included among the possible accommodation switch destinations, but selects the designated communication device of the accommodation switch destination when the designated communication device of the accommodation switch destination is included among the possible accommodation switch destinations. In this case, the communication devices to be selected include an edge router 20 and a LAG 200.

Referring back to FIG. 1, the description is continued. At least one edge router of the plurality of edge routers 20 is assigned to the device control unit 15. The device control unit 15 monitors the configuration input request management DB 14 on a regular basis, and acquires, from the device management unit 13, a configuration input request to which the identification information about the edge router 20 at the input destination is attached. The device control unit 15 then sets the user configuration designated by the configuration input request, in the edge router 20 identified by the identification information. This establishes communication between the edge router 20 and the user.

### Process According to the Embodiment

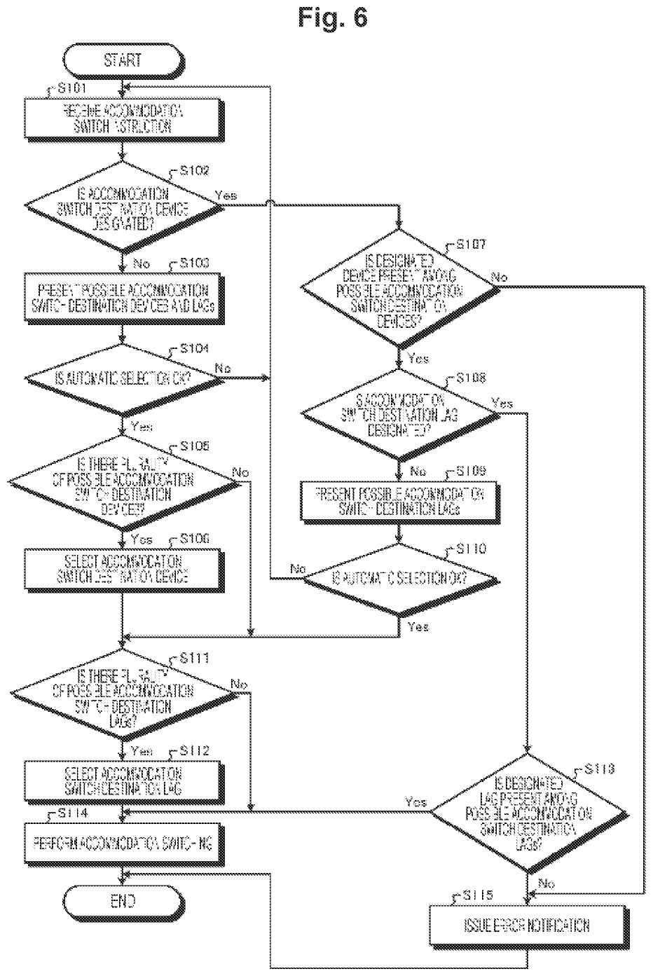

FIG. 6 is a flowchart of an accommodation switch process to be performed at the time of a maintenance accommodation switch by the centralized management server according to the embodiment. Next, the flow of an accommodation switch process at the time of a maintenance accommodation switch by the centralized management server 10 according to the embodiment is described with reference to FIG. 6.

The device management unit 13 monitors the configuration input request management DB 14, and receives an accommodation switch instruction through a configuration input request (step S101).

Next, the device management unit 13 acquires the user management information about the user whose accommodation positions are to be switched, from the management information storage unit 12. The device management unit 13 then selects and acquires the accommodation switch file 300 from among the accommodation switch files 300 stored in the external file 30, in accordance with the contract service, the accommodation area, the service provision status, and the like of the user whose accommodation positions are to be switched. Next, the device management unit 13 acquires information about the possible accommodation switch destination devices for the accommodation switch source device registered in the acquired accommodation switch file 300. The device management unit 13 further acquires information about the possible accommodation switch destination LAGs for the accommodation switch source LAG registered in the acquired accommodation switch file 300. Next, the device management unit 13 determines whether the accommodation switch destination device is designated in the accommodation switch instruction (step S102).

If the accommodation switch destination device is not designated (step S102: No), the device management unit 13 transmits possible accommodation switch destination devices and possible accommodation switch destination LAGs to the host system 40 via the host system handling unit 11, and presents these possible accommodation switch destination devices and LAGs to the maintenance worker (step S103).

The device management unit 13 then inquires of the maintenance worker whether automatic selection is permitted, and determines, from the response, whether automatic selection is permitted (step S104). If automatic selection is not permitted (step S104: No), the device management unit 13 makes a request for designation of the accommodation switch destination device and the accommodation switch destination LAG, and returns to step S101.

If automatic selection is permitted (step S104: Yes), on the other hand, the device management unit 13 determines whether there is a plurality of possible accommodation switch destinations (step S105). If there is one possible accommodation switch destination device (step S105: No), the device management unit 13 selects the one possible accommodation switch destination device as the accommodation switch destination device, and moves on to step S111.

If there is a plurality of possible accommodation switch destination devices (step S105: Yes), the device management unit 13 selects one accommodation switch destination device from among the possible accommodation switch destination devices, in accordance with the accommodation switch destination device selection logic registered in the accommodation switch file 300 (step S106). After that, the device management unit 13 moves on to step S111.

If the accommodation switch destination device is designated (step S102: Yes), on the other hand, the device management unit 13 determines whether the designated device is present among the possible accommodation switch destination devices (step S107). If the designated device is not present among the possible accommodation switch destination devices (step S107: No), the device management unit 13 issues an error notification (step S115).

If the designated device is present among the possible accommodation switch destination devices (step S107: Yes), on the other hand, the device management unit 13 selects the designated device as the accommodation switch destination device. Next, the device management unit 13 determines whether the accommodation switch destination LAG is designated (step S108).

If the accommodation switch destination LAG is not designated (step S108: No), the device management unit 13 transmits possible accommodation switch destination LAGs to the host system 40 via the host system handling unit 11, and presents these possible accommodation switch destination LAGs to the maintenance worker (step S109).

The device management unit 13 then inquires of the maintenance worker whether automatic selection is permitted, and determines, from the response, whether automatic selection is permitted (step S110). If automatic selection is not permitted (step S110: No), the device management unit 13 makes a request for designation of the accommodation switch destination LAG, and returns to step S101.

If automatic selection is permitted (step S110: Yes), on the other hand, the device management unit 13 moves on to step S111.

If there is one possible accommodation switch destination device (step S105: No), if the accommodation switch destination device is selected (step S106), or if the accommodation switch destination device is designated and automatic selection of the accommodation switch destination LAG is permitted (step S110: Yes), the device management unit 13 performs the following process. The device management unit 13 determines whether there is a plurality of possible accommodation switch destination LAGs (step S111). If there is one possible accommodation switch destination LAG (step S111: No), the device management unit 13 moves on to step S114.

If there is a plurality of possible accommodation switch destination LAGs (step S111: Yes), on the other hand, the device management unit 13 selects one accommodation switch destination LAG from among the possible accommodation switch destination LAGs, in accordance with the accommodation switch destination LAG selection logic registered in the accommodation switch file 300 (step S112). After that, the device management unit 13 moves on to step S114.

If the accommodation switch destination LAG 200 is designated (step S108: Yes), on the other hand, the device management unit 13 determines whether the designated LAG 200 is present among the possible accommodation switch destination LAGs (step S113).

If the designated LAG 200 is not present among the possible accommodation switch destination LAGs (step S113: No), the device management unit 13 issues an error notification (step S115).

If the designated LAG is present among the possible accommodation switch destination LAGs (step S113: Yes), on the other hand, the device management unit 13 selects the designated LAG as the accommodation switch destination LAG, and moves on to step S114.

If neither the accommodation switch destination device nor the accommodation switch destination LAG is designated, and both the accommodation switch destination device and the accommodation switch destination LAG are selected (step S112), or if both the accommodation switch destination device and the accommodation switch destination LAG are designated, and both the accommodation switch destination device and the accommodation switch destination LAG are present among the possible accommodation switch destination devices and the possible accommodation switch destination LAGs (step S113: Yes), the device management unit 13 performs the following process. The device management unit 13 switches the accommodation of the user to the selected accommodation switch destination device and accommodation switch destination LAG (step S114).

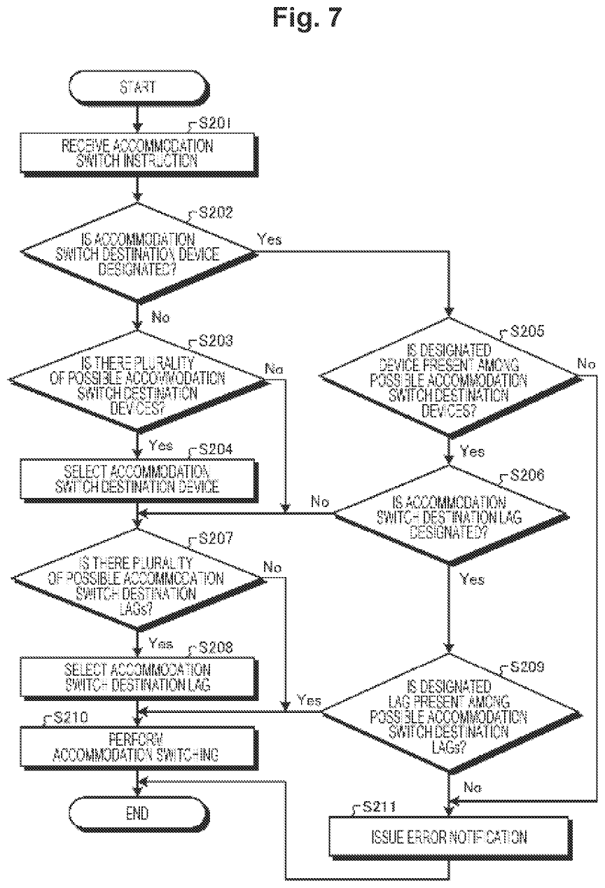

FIG. 7 is a flowchart of an accommodation switch process to be performed at the time of a failure accommodation switch by the centralized management server according to the embodiment. Next, the flow of an accommodation switch process at the time of a failure accommodation switch by the centralized management server 10 according to the embodiment is described with reference to FIG. 7.

The device management unit 13 monitors the configuration input request management DB 14, and receives an accommodation switch instruction through a configuration input request (step S201).

Next, the device management unit 13 acquires the user management information about the user whose accommodation positions are to be switched, from the management information storage unit 12. The device management unit 13 then selects and acquires the accommodation switch file 300 from among the accommodation switch files 300 stored in the external file 30, in accordance with the contract service, the accommodation area, the service provision status, and the like of the user whose accommodation positions are to be switched. Next, the device management unit 13 acquires information about the possible accommodation switch destination devices for the accommodation switch source device registered in the acquired accommodation switch file 300. The device management unit 13 further acquires information about the possible accommodation switch destination LAGs for the accommodation switch source LAG registered in the acquired accommodation switch file 300. Next, the device management unit 13 determines whether the accommodation switch destination device is designated in the accommodation switch instruction (step S202).

If the accommodation switch destination device is not designated (step S202: No), the device management unit 13 determines whether there is a plurality of possible accommodation switch destinations (step S203). If there is one possible accommodation switch destination device (step S203: No), the device management unit 13 selects the one possible accommodation switch destination device as the accommodation switch destination device, and moves on to step S207.

If there is a plurality of possible accommodation switch destination devices (step S203: Yes), the device management unit 13 selects one accommodation switch destination device from among the possible accommodation switch destination devices, in accordance with the accommodation switch destination device selection logic registered in the accommodation switch file 300 (step S204). After that, the device management unit 13 moves on to step S207.

If the accommodation switch destination device is designated (step S202: Yes), on the other hand, the device management unit 13 determines whether the designated device is present among the possible accommodation switch destination devices (step S205). If the designated device is not present among the possible accommodation switch destination devices (step 3205: No), the device management unit 13 issues an error notification (step S211).

If the designated device is present among the possible accommodation switch destination devices (step S205: Yes), on the other hand, the device management unit 13 selects the designated device as the accommodation switch destination device. Next, the device management unit 13 determines whether the accommodation switch destination LAG is designated (step S206).

If the accommodation switch destination LAG is not designated (step S206: No), the device management unit 13 moves on to step S207.

If there is one possible accommodation switch destination device (step S203: No), if the accommodation switch destination device is selected (step S204), or if the accommodation switch destination device is designated but the accommodation switch destination LAG is not designated (step S206: No), the device management unit 13 performs the following process. The device management unit 13 determines whether there is a plurality of possible accommodation switch destination LAGs (step S207). If there is one possible accommodation switch destination LAG (step S207: No), the device management unit 13 moves on to step S210.

If there is a plurality of possible accommodation switch destination LAGs (step S207: Yes), on the other hand, the device management unit 13 selects one accommodation switch destination LAG from among the possible accommodation switch destination LAGs, in accordance with the accommodation switch destination LAG selection logic registered in the accommodation switch file 300 (step S208). After that, the device management unit 13 moves on to step S210.

If the accommodation switch destination LAG is designated (step S206: Yes), on the other hand, the device management unit 13 determines whether the designated LAG 200 is present among the possible accommodation switch destination LAGs (step S209).

If the designated LAG 200 is not present among the possible accommodation switch destination LAGs (step S209: No), the device management unit 13 issues an error notification (step S211).

If the designated LAG is present among the possible accommodation switch destination LAGs (step S209: Yes), on the other hand, the device management unit 13 selects the designated LAG as the accommodation switch destination LAG, and moves on to step S210.

If neither the accommodation switch destination device nor the accommodation switch destination LAG is designated, and both the accommodation switch destination device and the accommodation switch destination LAG are selected (step S208), or if both the accommodation switch destination device and the accommodation switch destination LAG are designated, and both the accommodation switch destination device and the accommodation switch destination LAG are present among the possible accommodation switch destination devices and the possible accommodation switch destination LAGs (step S209: Yes), the device management unit 13 performs the following process. The device management unit 13 switches the accommodation of the user to the selected accommodation switch destination device and accommodation switch destination LAG (step S210).

### Effects of the Embodiment

As described above, in a case where an accommodation switch instruction is issued, the device management unit 13 of the centralized management server 10 checks the accommodation switch file 300 in which the possible accommodation switch destination devices corresponding to the accommodation switch source device and the possible accommodation switch destination LAGs corresponding to the accommodation switch source LAG are written. Further, in a case where the accommodation switch destination device and the accommodation switch destination LAG are designated, the device management unit 13 checks whether the accommodation switch destination device and LAG are included among the possible accommodation switch destination devices and the possible accommodation switch destination LAGs, and, if the accommodation switch destination device and LAG are not included among the possible accommodation switch destination devices and LAGs, issues an error notification. On the other hand, in a case where the designated device and LAG 200 are included among the possible accommodation switch destination devices and the possible accommodation switch destination LAGs, the edge router 20 to be the accommodation switch destination device, and the LAG 200 to be the accommodation switch destination LAG are selected in accordance with the designation. Further, in a case where the accommodation switch destination device and the accommodation switch destination LAG are not designated, the device management unit 13 selects the edge router 20 to be the accommodation switch destination device, and the LAG 200 to be the accommodation switch destination LAG, in accordance with a predetermined algorithm.

With this configuration, it is possible to limit the edge routers 20 and the LAGs 200 as pairs that can accommodate users in the same edge group, without great development in the centralized management server 10. In addition to the range in which accommodation switching can be performed as viewed from the centralized management server 10, it is possible to set a range of the edge router 20 to be the accommodation switch destination, in terms of an external system or operation. Further, with the information about the possible accommodation switch destinations and the selection logics registered in the accommodation switch file 300, which is the external file 30, it is possible to flexibly and easily change the limitations even when an examination is skipped at the design construction stage or a requirement change occurs in the future. Furthermore, as the selection logics are registered as a file in the accommodation switch file 300 and are selected in accordance with situations, a higher-speed selection logic can be selected in an emergency such as a large-scale disaster, for example, and the recovery of user communications can be accelerated. In this manner, it is possible to flexibly cope with limitations on accommodation switch destinations. Further, as a checking function regarding limitations and automatic selection is provided, it is possible to reduce operational errors by the maintenance personnel.

### [System Configuration and Others]

Moreover, the respective components of the respective devices illustrated in the drawings are functionally conceptual, and do not necessarily need to be physically constructed as illustrated. That is, a specific form of distribution and integration of the respective devices is not limited to the illustrated form, and all or some of the devices can be functionally or physically distributed or integrated in any unit, depending on various loads, usage conditions, and the like. Further, all or some of the respective processing functions to be executed performed in the respective devices can be implemented by a central processing unit (CPU) and a program analyzed and executed by the CPU, or may be implemented as hardware by wired logic.

Also, among the respective processes described in this embodiment, all or some of the processes described as being automatically performed can be manually performed, or all or some of the processes described as being manually performed can be automatically performed by a known method. In addition to the above, the processing procedures, the control procedures, the specific names, and the information including various kinds of data and parameters that are illustrated in the above literatures and drawings can be changed as appropriate, unless otherwise specified.

### [Program]

As an embodiment, the centralized management server 10 can be implemented by installing a management program for performing the above management processes as packaged software or online software in a desired computer. For example, by causing an information processing device to execute the above management program, it is possible to cause the information processing device to function as the centralized management server 10. The information processing device mentioned herein may be a desktop or a laptop personal computer. Alternatively, the information processing device may be a mobile communication terminal such as a smartphone, a mobile phone, and a personal handy-phone system (PHS), a slate terminal such as a personal digital assistant (PDA), or the like. The centralized management server 10 may be implemented as a web server, or may be implemented as a cloud that provides services related to the management processes described above by outsourcing.

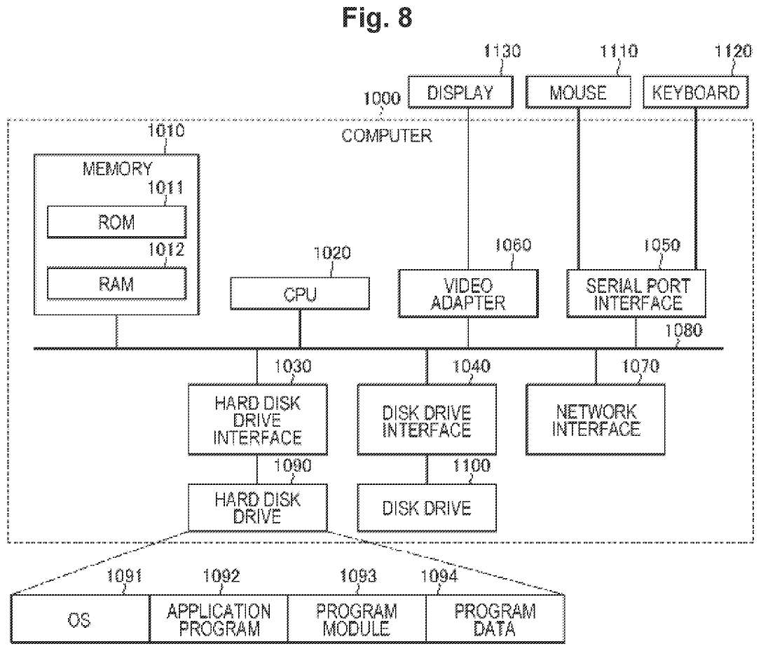

FIG. 8 is a diagram illustrating an example of a computer that executes the management program. A computer 1000 includes a memory 1010 and a CPU 1020, for example. The computer 1000 also includes a hard disk drive interface 1030, a disk drive interface 1040, a serial port interface 1050, a video adapter 1060, and a network interface 1070. These components are connected by a bus 1080.

The memory 1010 includes a read only memory (ROM) 1011 and a random access memory (RAM) 1012. The ROM 1011 stores a boot program such as a basic input output system (BIOS), for example. The hard disk drive interface 1030 is connected to a hard disk drive 1090. The disk drive interface 1040 is connected to a disk drive 1100. For example, a removable storage medium such as a magnetic disk or an optical disk is inserted into the disk drive 1100. The serial port interface 1050 is connected to a mouse 1110 and a keyboard 1120, for example. The video adapter 1060 is connected to a display 1130, for example.

The hard disk drive 1090 stores an OS 1091, an application program 1092, a program module 1093, and program data 1094, for example. That is, the program that defines the respective processes to be performed by the centralized management server 10 and has functions equivalent to those of the centralized management server 10 is implemented as the program module 1093 in which codes are written and can be executed by the computer. The program module 1093 is stored in the hard disk drive 1090, for example. For example, the program module 1093 for executing processes similar to those of the functional components in the centralized management server 10 is stored in the hard disk drive 1090. Note that the hard disk drive 1090 may be replaced with a solid state drive (SSD).

Further, the setting data to be used in the processes according to the above embodiment is stored as the program data 1094 in the memory 1010 or the hard disk drive 1090, for example. The CPU 1020 then reads the program module 1093 and the program data 1094 stored in the memory 1010 and the hard disk drive 1090 into the RAM 1012 as necessary, and performs the processes according to the above embodiment.

Note that the program module 1093 and the program data 1094 are not necessarily stored in the hard disk drive 1090, but may be stored in a removable storage medium, for example, and be read by the CPU 1020 via the disk drive 1100 or the like. Alternatively, the program module 1093 and the program data 1094 may be stored in another computer connected via a network (a local area network (LAN), a wide area network (WAN), or the like). Further, the program module 1093 and the program data 1094 may be read by the CPU 1020 from another computer via the network interface 1070.

### REFERENCE SIGNS LIST

1 Management system
10 Centralized management server
11 Host system handling unit
12 Management information storage unit
13 Device management unit
14 Configuration input request management DB
15 Device control unit
20 to 26 Edge router
40 External file
50 Host system
50 DHCP server
51 Authentication information DB
300 Accommodation switch file
200, 211 to 213, 221 to 223, 231 to 233, 241 to 243, 251 to 253, 261 to 263 LAG

1. A management device comprising:
a host system handling unit, comprising one or more processors, configured to receive an accommodation switch instruction for switching an accommodation position of a specific user accommodated in a predetermined communication device to another communication device, the predetermined communication device being included in a plurality of communication devices accommodating users who use a network;
a device management unit, comprising one or more processors, configured to acquire information about possible accommodation switch destinations corresponding to the predetermined communication device from an external file in which at least one of the communication devices to be an accommodation switch destination is associated with each of the communication devices and is registered, and select a communication device to be an accommodation switch destination from among the acquired possible accommodation switch destinations; and
a device control unit, comprising one or more processors, configured to perform accommodation switching so that the specific user is accommodated in the communication device of the accommodation switch destination selected by the device management unit.

2. The management device according to claim 1, wherein, when designation of the communication device of the accommodation switch destination is included in the accommodation switch instruction, the device management unit is configured to issue an error notification when the designated communication device of the accommodation switch destination is not included among the possible accommodation switch destinations, and select the designated communication device of the accommodation switch destination when the designated communication device of the accommodation switch destination is included among the possible accommodation switch destinations.

3. The management device according to claim 1, wherein the device management unit is configured to automatically select the communication device of the accommodation switch destination from among the possible accommodation switch destinations, using a logic designated among a plurality of logics registered beforehand in the external file.

4. The management device according to claim 1, wherein
the external file includes a plurality of individual files in which the possible accommodation switch destinations are registered in accordance with user management information indicating the user's usage state of the network, and
the device management unit is configured to acquire the user management information about the specific user, select the individual file on the basis of the acquired user management information about the specific user, and perform the selection using the possible accommodation switch destinations registered in the selected individual file.

5. A management method comprising:
receiving an accommodation switch instruction for switching an accommodation position of a specific user accommodated in a predetermined communication device to another communication device, the predetermined communication device being included in a plurality of communication devices accommodating users who use a network;
acquiring information about possible accommodation switch destinations corresponding to the predetermined communication device from an external file in which at least one of the communication devices to be an accommodation switch destination is associated with each of the communication devices and is registered, and selecting a communication device to be an accommodation switch destination from among the acquired possible accommodation switch destinations; and
performing accommodation switching so that the specific user is accommodated in the communication device of the accommodation switch destination selected in the device management step.

6. A non-transitory computer readable medium storing a program, wherein execution of the program causes a computer to perform operations comprising:
receiving an accommodation switch instruction for switching an accommodation position of a specific user accommodated in a predetermined communication device to another communication device, the predetermined communication device being included in a plurality of communication devices accommodating users who use a network;
acquiring information about possible accommodation switch destinations corresponding to the predetermined communication device from an external file in which at least one of the communication devices to be an accommodation switch destination is associated with each of the communication devices and is registered, and selecting a communication device to be an accommodation switch destination from among the acquired possible accommodation switch destinations; and
performing accommodation switching so that the specific user is accommodated in the selected communication device of the accommodation switch destination.
